(19) United States
(12) Patent Application Publication
(10) Pub. No.: US 2016/0035327 A1
(43) Pub. Date: Feb. 4, 2016

(54) SOPRANO SAXOPHONE

(71) Applicant: Rheuben A. Allen, Torrance, CA (US)

(72) Inventor: Rheuben A. Allen, Torrance, CA (US)

(21) Appl. No.: 14/449,470

(22) Filed: Aug. 1, 2014

(51) Int. Cl. G10D 7/08

(52) U.S. Cl. CPC G10D 7/08

(57) ABSTRACT

A soprano saxophone having a combination of modern palm key designs with the bore and left had lower keys of an earlier soprano saxophone design placed along the main body thereof in a manner whereby a saxophonist experienced with other types of saxophones can easily play the soprano saxophone.

### BACKGROUND OF THE INVENTION

1. Field of the Invention

The present invention provides a soprano saxophone that improves upon currently available saxophones.

2. Description of the Prior Art

The history of the saxophone is well known to music aficionados; in brief, Antoine-Joseph Sax invented the saxophone (a C bass version, although subsequently a family of fourteen saxophones were created, each differing in pitch) in 1841 to provide an instrument that produced a sound lying between the woodwind sound of a clarinet and the brass tone of a trumpet.

Since the invention of the saxophone, few changes to the basic configuration have been suggested. For example, U.S. Pat. No. 4,148,242 to Woehr et al discloses a saxophone that has been modified by placing a key adjacent the thumb rest and linked to the B flat key for playing the Bb noted in the lower register with the thumb of the left hand.

Conventional soprano saxophones leave the placement of the tone holes inline, the palm key placement that is inline and a Front F key which is not located above the B pearl key, factors which make it difficult for a musician skilled in playing other saxophones to adapt to playing the soprano saxophone.

It would be desirable if the soprano saxophone could be modified so that a musician used to playing alto, tenor or baritone saxophones could easily adjust to playing a soprano saxophone.

### SUMMARY OF THE PRESENT INVENTION

The present invention provides a modified version of the early Selmer Straight soprano saxophone that enables the saxophonist to switch between playing the alto, tenor or baritone saxophones to the soprano saxophone.

The Palm D key, Palm E-Flat (D-sharp) and Palm F key placements in accordance with the inventor, allow the saxophonist to switch between saxophones as noted hereinabove as opposed to the original palm key design on the saxophone tube (bore) that was inline and difficult to switch back and forth because of the different fingering.

The palm key tone holes are soldered on the body of the soprano saxophone enabling better intonation (pitch) and response of the highest note of the soprano saxophone.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view of a conventional soprano saxophone;

FIG. 2 is a perspective view of a soprano saxophone modified with the keys of the present invention; and

FIG. 3 is a detail showing a portion of the soprano saxophone shown in FIG. 2.

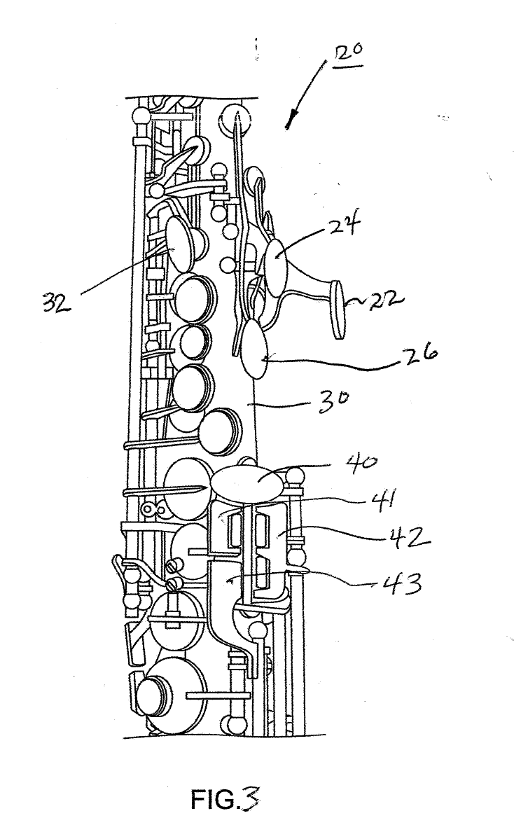

### DESCRIPTION OF THE INVENTION

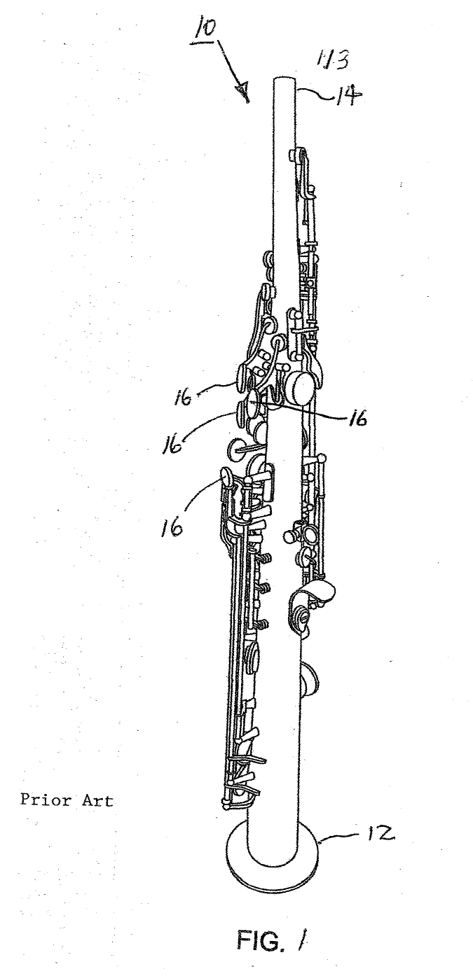

FIG. 1 illustrates a conventional soprano saxophone 10 having a sound emitting end, or horn, portion, 12, end 14 to receive a mouthpiece portion (not shown) and a plurality of keys 16. The palm keys are inline and the Front F key is spaced from the B pearl key. Further details of the saxophone 10 will not be set forth in the interests of brevity and with the knowledge that the soprano saxophone is well known in the musical arts.

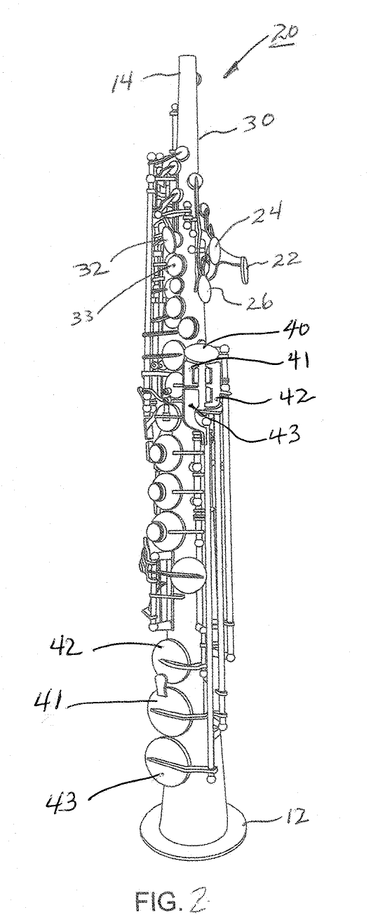

FIG. 2 is a perspective view of a soprano saxophone 20 modified in accordance with the teachings of the present invention. In order to provide the reader with clarity regarding the invention, the terms used in the description that follows will now be set forth.

Palm Keys: The term Palm Keys refers to the keys at the top of the saxophone (near the mouthpiece) that are operated by the palm of the left hand. The palm keys include the high D key 22, the high D-Sharp/E-Flat key 24 and the F key 26. The palm key placement basically emulates the key placement for the modern alto, tenor and baritone palm key designs. This feature enables musicians skilled in the playing of alto, tenor or baritone saxophones to easily switch to soprano saxophones since the finger patterns on each saxophone will be the same.

Tube or Main Body of the Saxophone 30: This is the part of the saxophone 20 that has the tone holes and is where the keys are soldered.

Articulated G-Sharp Key: This enables a musician to play from a Low B-Flat to a G-Sharp (A-Flat) while holding the Low B-Flat key down (the G-Sharp key will automatically open when going from Low B-Flat to G-Sharp (A-Flat)). It is not necessary to move the left hand little finger from the Low B-Flat to the G-Sharp (A-Flat) to produce the G-Sharp.

Left Hand Little Finger Keys: These are the keys that are operated by using the little finger of the left hand. These include the Low B-Flat key 40, Low B key 41, Low C-Sharp key 42 and the G-Sharp key 43 used on older soprano saxophones. The left hand little finger keys are designed to have the Low B-Flat, Low B and Low C-Sharp pad cups and tone holes on the top of the main body of the saxophone as opposed to the modern soprano saxophone design that has the tone holes on the back side of the main body and the little finger levers that operate the keys, work in the opposite direction (modern key design pulls the left hand little fingers to the left of the main body; the key placement according to the present invention, the left hand little levers, or keys, pull the fingers to the right side of the main body). These keys operate by pushing the key from left to right and down with the left hand little finger.

Tone Hole: The tone hole of the saxophone is the round hole in the main body of the saxophone that allows the note to come out and be a certain pitch.

Drawn Tone Holes: A drawn tone hole on the saxophone is formed by drawing from the brass of the main body of the saxophone.

Soldered on Tone Holes: The soldered on tone hole is made from a different piece of brass and there is a round hole made in the main body of the saxophone and the tone hole is soldered over the hole. The main advantage to the soldered tone hole is when a tone is drawn there is only so much material and the tone hole can only be so tall. With the soldered on tone hole it can be any height and diameter. Since the tone holes on the top of the soprano saxophone are so small, drawn tone holes cannot produce the desired height to produce the correct pitch and/or response. This is provided by using the soldered tone holes to control the notes in accordance with the teachings of the present invention.

The Front F or Harmonic Key 32 (also sometimes called the Altissimo Key) placement is unique in that there are two operating levers or keys that can be interchanged and is located above the B pearl key 33.

One of the levers opens the Plam F pad cup when working the Front F. Saxophonists that play the high notes a little flat in the upper register usually use this key to open the F pad cup when operating the Front F key.

The second key when placed on the soprano saxophone opens the Palm E pad cup when operating the Front F Key. Saxophonists that play the upper register of the soprano saxophone either a little sharp or really well in tune like the Front F key to open the E pad cup (this is the key that was opened on the soprano saxophones that did not have a Front F key by using the right hand palm E key to produce the higher register of the soprano saxophone) when operating the Front F key (a pad cup is the part of the saxophone key that holds the pad. There are two kinds of keys on a saxophone; one that has a pad cup on it and one that is an operating lever without a pad connected to it).

Using the modern style design for the Palm Keys makes it easier for the saxophone player to switch from alto, tenor or baritone saxophones to the soprano saxophone since most of these instruments have a modern key design. When choosing the placement of these keys, the placement of the tone holes are matched and inline. In order to compensate for different hand sizes of a player, the palm D key was placed away from the main body of the saxophone since this key is the only one played with the real palm of the hand. The Palm E-flat key is lowered so the left hand could remain over the pearl keys of the upper stack keys of the soprano saxophone and not in the way when playing from the natural range of the saxophone to the palm keys. The Palm F key is set high enough that it can be reached easily but not in the way when going from the stack keys to the Palm D or E-Flat.

The arrangement of tone holes and keys as set forth hereinabove enable musicians skilled in playing the alto, tenor or baritone saxophones to play a soprano saxophone with relative ease.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A soprano saxophone having the capability of enabling tenor, alto and baritone saxophonists to easily switch to the soprano saxophone, the soprano saxophone having a main body with upper and lower ends, a plurality of palm keys placed adjacent the top end of said main body, a B key, a Front F key and a plurality of offset tone holes soldered to said main body.

2. The saxophone of claim 1 wherein said palm keys comprise high D, D-sharp/E-flat, E and F keys.

3. (canceled)

4. The saxophone of claim 1 wherein said Front F key is closer to the upper end of said main body than said B key.
